(19) United States
(12) Patent Application Publication
(10) Pub. No.: US 2025/0219415 A1
(43) Pub. Date: Jul. 3, 2025

(54) HYDRAULIC FULL-PERIOD FREQUENCY MODULATION NEW ENERGY GENERATOR SET PRIMARY FREQUENCY MODULATION METHOD THEREOF AND GENERATOR SET

(71) Applicant: Yanshan University, Qinhuangdao (CN)

(72) Inventor: Wenting CHEN, Qinhuangdao (CN)

(21) Appl. No.: 19/001,697

(22) Filed: Dec. 26, 2024

(30) Foreign Application Priority Data
Dec. 28, 2023 (CN) 2023118374840

(51) Int. Cl. H02J 3/04; H02K 7/18

(52) U.S. Cl. CPC H02J 3/04; H02K 7/1823

(57) ABSTRACT

The present disclosure relates to a primary frequency modulation method for a hydraulic full-period frequency modulation new energy generator set and a generator set therefor, belonging to the technical field of frequency modulation for hydraulic new energy generator sets. The method includes determining whether a grid frequency is within a rated frequency threshold. When the grid frequency deviates from the rated frequency threshold, the stability of the grid frequency is controlled by adjusting a rotor kinetic energy of a blade and an opening of the proportional throttle valve, energy storage and supply by using a bladder accumulator, and hydraulic energy storage and supply. The hydraulic energy storage and supply of the present disclosure can store more energy and provide a longer frequency modulation period. By employing a combined wind-storage approach for comprehensive frequency modulation control, and an anti-interference capability of the frequency of the entire hydraulic new energy generator set can be enhanced.

### TECHNICAL FIELD

The present disclosure relates to the technical field of frequency modulation for hydraulic new energy generator sets, and particularly to a primary frequency modulation method for a hydraulic full-period frequency modulation new energy generator set and the generator set therefor.

### BACKGROUND

Under continuous impact of fossil energy consumption and environmental crises, people have begun to explore new clean energy sources. Compared to coal, oil, and natural gas, clean and renewable energy sources, such as wind energy, ocean current energy, and wave energy, have enormous reserves and do not emit greenhouse gases during electricity production. These energy sources have gained significant attention from various countries, prompting an acceleration in energy transition. Among them, hydraulic new energy generator sets, as a new generation of new energy power generation equipment, have attracted widespread attention due to their real-time adjustable transmission ratio, enabling flexible control and mitigating the impact of new energy supply fluctuations on power quality. Although clean renewable energy sources are abundant, their variability is significant, and the challenge of how hydraulic new energy generator sets can provide stable power remains to be solved.

With continuous increase in installed capacity and penetration rate of hydraulic new energy generator sets, the requirements for primary frequency modulation are also rising. Traditional grid frequency modulation can be primarily achieved through thermal or hydroelectric power units. However, hydraulic new energy generator sets not only lack inherent regulation capabilities but also increase the grid's frequency modulation burden due to the intermittent and random nature of their output power. Existing primary frequency modulation control methods for doubly-fed induction wind turbines include inertia control, droop control, overspeed control, pitch control, and step control. While these methods partially address the frequency modulation issues of wind turbines, they are susceptible to external influences, causing grid frequency fluctuations again, frequent actions of wind turbines, and reducing wind energy utilization and turbine lifespan.

Hydraulic energy storage systems are an optimal choice for enabling the hydraulic new energy generator sets to achieve the primary frequency modulation, providing rapid power regulation capabilities. Traditional energy storage methods mainly involve energy storage through accumulators for grid primary frequency modulation. However, their capacity is limited and does not support a tertiary frequency modulation. When facing longer periods and larger capacity frequency modulation requirements, the traditional energy storage methods encounter challenges.

As above described, during the power generation process of the hydraulic new energy generator sets, a primary issue is grid frequency fluctuations caused by imbalance between power supply and demand due to uncontrollability of new energy resources. Additionally, traditional accumulator-based energy storage frequency modulation faces limitations in meeting longer-term and larger-capacity frequency modulation requirements.

### SUMMARY

In response to the limitations of existing technologies, the present disclosure provides a primary frequency modulation method for a hydraulic full-period frequency modulation new energy generator set and the generator set therefor. The method proposes a multi-stage primary frequency modulation approach based on different wind conditions, which includes adjusting a rotor kinetic energy of blades and an opening of a proportional throttle valve, energy storage and supply by using a bladder accumulator, and hydraulic energy storage and supply. This can achieve dynamic balance in an output power of the hydraulic new energy generator set. Additionally, the hydraulic energy storage and supply can address frequency modulation requirements over longer periods and larger capacities.

In order to achieve the above objectives, the present disclosure provides following technical solutions:

On one aspect, the present disclosure provides a primary frequency modulation method for a hydraulic full-period frequency modulation new energy generator set, including following steps:
S1: determining whether a grid frequency is within a rated frequency threshold; if the grid frequency is higher than the rated frequency threshold, performing step S2; if the grid frequency is lower than the rated frequency threshold, performing step S3;
S2: when the grid frequency is higher than the rated frequency threshold, the hydraulic new energy generator set performs frequency modulation to bring the grid frequency within the rated frequency threshold, specifically including following sub-steps:
S21: performing an initial frequency modulation by reducing a blade rotor kinetic energy and decreasing a valve opening of a proportional throttle valve; during the frequency modulation, determining whether the grid frequency is within the rated frequency threshold in real time; if the grid frequency reaches the rated frequency threshold, the frequency modulation ends; if the blade rotor kinetic energy and the valve opening of the proportional throttle valve both reach minimum thresholds and the grid frequency remains higher than the rated frequency threshold, performing step S22;
S22: performing a secondary frequency modulation by using a second bidirectional variable hydraulic motor and the energy conversion element functioning as a hydraulic pump to store excess energy as hydraulic energy in a bladder accumulator; during the frequency modulation, determining whether the grid frequency is within the rated frequency threshold in real time; if the grid frequency reaches the rated frequency threshold, the frequency modulation ends; if the bladder accumulator is fully charged with the hydraulic energy and the grid frequency remains higher than the rated frequency threshold, performing step S23;
S23: performing a tertiary frequency modulation by using the excess energy generated by blades to drive the second bidirectional variable hydraulic motor, thereby driving a water pump to store seawater as hydraulic energy in a water storage tank; during the frequency modulation, determining whether the grid frequency is within the rated frequency threshold in real time; if the grid frequency reaches the rated frequency threshold, the frequency modulation ends;
S3: when the grid frequency is lower than the rated frequency threshold, the hydraulic new energy generator set performs frequency modulation to bring the grid frequency within the rated frequency threshold, specifically including following sub-steps:
S31: performing the initial frequency modulation by increasing the blade rotor kinetic energy through frequency control and increasing the valve opening of the proportional throttle valve; during the frequency modulation, determining whether the grid frequency is within the rated frequency threshold in real time; if the grid frequency reaches the rated frequency threshold, the frequency modulation ends; if both the blade rotor kinetic energy and the valve opening of the proportional throttle valve reach the maximum thresholds and the grid frequency remains lower than the rated frequency threshold, performing step S32;
S32: performing the secondary frequency modulation by releasing the hydraulic energy stored in the bladder accumulator to drive the energy conversion element functioning as a hydraulic motor, thereby driving the third excitation synchronous generator to generate electricity; during the frequency modulation, determining whether the grid frequency is within the rated frequency threshold in real time; if the grid frequency reaches the rated frequency threshold, the frequency modulation ends; if the hydraulic energy in the bladder accumulator is fully released and the grid frequency remains lower than the rated frequency threshold, performing step S33;
S33: performing the tertiary frequency modulation by allowing the seawater stored in the water storage tank to flow downward, driving a water turbine to rotate and thereby driving a second excitation synchronous generator to generate electricity; during the frequency modulation, determining whether the grid frequency is within the rated frequency threshold in real time; when the grid frequency reaches the rated frequency threshold, the frequency modulation ends.

Preferably, in step S31, when the hydraulic new energy generator set performs the initial frequency modulation, the blade rotor kinetic energy is adjusted through frequency control to meet the frequency modulation requirement; the frequency modulation requirement is a rotational inertia of a first excitation synchronous generator, which is:

$${J}_{virl} = \frac{{J}_{w} {ω}_{w 0} {Δω}_{w}}{{ω}_{s} {Δω}_{s}}$$

wherein Jₛ is a total inertia of the blade and a load converted to a blade shaft; ω_{w0} is a rotational speed under maximum power point tracking; and ωₛ is a synchronous speed;

$${Δω}_{w} = {ω}_{w 1} - {ω}_{w 0}$$

wherein ω_{w1} is a minimum operating speed of the blade;

$${Δω}_{s} = {ω}_{s 1} - {ω}_{s}$$

wherein ωₛ₁ is the rotational speed of the generator after meeting the frequency modulation requirement;
by adjusting an output active power, a rotational kinetic energy of the blade is used to support a rotor kinetic energy of the generator to compensate for the power; the active power compensated by a virtual inertia control of the blade is:

$$Δ {P}_{1} = - {K}_{df} \frac{d Δ f}{dt}$$

wherein ΔP₁ is the power compensated by the virtual inertia control; Δf is a system frequency deviation; and K_{df} is a virtual inertia coefficient.

Preferably, when the hydraulic new energy generator set performs the secondary frequency modulation, a frequency variation is introduced to implement additional control on a hydraulic energy storage system; the virtual droop control is used to respond to system frequency changes; the active power compensated by the virtual droop control of the blade is:

$$Δ {P}_{2} = - {K}_{pf} Δ f$$

wherein ΔP₂ is a power compensated by the virtual droop control; K_{pf} is a virtual droop coefficient; and Δf is a system frequency deviation.

Preferably, wherein the rated frequency threshold is 50±0.2 Hz.

On the other aspect, the present disclosure provides a hydraulic full-period frequency modulation new energy generator set for implementing the primary frequency modulation method according to claim 1, including: a blade, an unidirectional fixed-displacement hydraulic pump, a proportional throttle valve, a first bidirectional variable hydraulic motor, a second bidirectional variable hydraulic motor, a first excitation synchronous generator, a second excitation synchronous generator, a third excitation synchronous generator, a water turbine, a water valve, a water storage tank, a water pump, a bladder accumulator, an energy conversion element, a first hydraulic oil tank, a second hydraulic oil tank, a first overflow valve, a second overflow valve, a generator, a make-up pump, and a check valve; and the first excitation synchronous generator, the second excitation synchronous generator, and the third excitation synchronous generator being all connected to the grid; wherein the blade is connected to the unidirectional fixed-displacement hydraulic pump; an inlet of the second overflow valve is connected to an outlet of the unidirectional fixed-displacement hydraulic pump, and an outlet of the second overflow valve is connected to an inlet of the unidirectional fixed-displacement hydraulic pump; an inlet of the proportional throttle valve is connected to an outlet of the unidirectional fixed-displacement hydraulic pump; an inlet of the first bidirectional variable hydraulic motor is connected to an outlet of the proportional throttle valve, and an outlet of the first bidirectional variable hydraulic motor is connected to an inlet of the unidirectional fixed-displacement hydraulic pump; the first excitation synchronous generator is connected to the first bidirectional variable hydraulic motor; wherein an inlet of the second bidirectional variable hydraulic motor is connected to the outlet of the proportional throttle valve; the second bidirectional variable hydraulic motor is connected to the energy conversion element; the energy conversion element is connected to the bladder accumulator and the first hydraulic oil tank; the energy conversion element is also connected to the water pump; the water pump is connected to the third excitation synchronous generator; the water pump is connected to an inlet of the water storage tank; the inlet of the water valve is connected to an outlet of the water storage tank; and the outlet of the water valve is connected to the water turbine; and the water turbine is connected to the second excitation synchronous generator; wherein an inlet of the check valve is connected to an outlet of the unidirectional fixed-displacement hydraulic pump, and an outlet of the check valve is connected to an outlet of the make-up pump and the inlet of the first overflow valve; the generator drives the make-up pump, and the inlet of the make-up pump and the outlet of the first overflow valve are both connected to the second hydraulic oil tank.

Preferably, the unidirectional fixed-displacement hydraulic pump, the proportional throttle valve, the first bidirectional variable hydraulic motor, and the second bidirectional variable hydraulic motor form a hydraulic closed-loop circuit.

Preferably, the check valve, the first overflow valve, the make-up pump, and the generator form a hydraulic make-up circuit.

Preferably, the blade is connected to the unidirectional fixed-displacement hydraulic pump through a first coupler; the first excitation synchronous generator is connected to the first bidirectional variable hydraulic motor through a second coupler; the second bidirectional variable hydraulic motor is connected to the energy conversion element through a third coupler; the energy conversion element is connected to the water pump through a fourth coupler; and the water pump is connected to the third excitation synchronous generator through a fifth coupler.

Preferably, the first excitation synchronous generator is connected to a first grid-connected cabinet and then connected to the grid; the second excitation synchronous generator is connected to a second grid-connected cabinet and then connected to the grid; the third excitation synchronous generator is connected to a third grid-connected cabinet and then connected to the grid.

Compared with the existing technologies, the present disclosure has the following advantages:

1. The present disclosure can be applied to terrains such as offshore highlands or islands, where abundant wind energy, ocean current energy, and wave energy are available. It fully utilizes these clean renewable energy sources and land resources.

2. The present disclosure incorporates a frequency modulation unit in the hydraulic new energy generator set. Based on a conventional hydraulic frequency modulation system, the present disclosure designs four primary frequency modulation methods and employs a combined wind-storage approach for comprehensive frequency modulation control. This can ensure a balance between the power supply on the energy side and the power demand on the load side, enhancing the anti-interference capability of frequency of the entire hydraulic new energy generator set.

3. A tertiary frequency modulation of the present disclosure operates through power generation by the water turbine. The hydraulic energy storage and supply can address frequency modulation requirements over longer periods and larger capacities.

### BRIEF DESCRIPTION OF THE DRAWINGS

FIG. 1 is a schematic view of a hydraulic full-period frequency modulation new energy generator set according to the present disclosure.

FIG. 2 is a view of a full frequency range frequency modulation strategy for the hydraulic full-period frequency modulation new energy generator set according to the present disclosure.

FIG. 3 is a simulation view of a system response when a load of the hydraulic full-period frequency modulation new energy generator set according to the present disclosure suddenly increases by 10.5 kW.

FIG. 4 is a simulation view of the system response when the load of the hydraulic full-period frequency modulation new energy generator set according to the present disclosure suddenly increases by 12 kW.

FIG. 5 is a simulation view of the system response when the load of the hydraulic full-period frequency modulation new energy generator set according to the present disclosure suddenly decreases by 6 kW.

### DETAILED DESCRIPTION

In order to elaborate technical content, objectives, and effects achieved by the present disclosure, a detailed explanation will be provided in conjunction with the accompanying drawings in the specification.

On one aspect, the present disclosure provides a primary frequency modulation method for a hydraulic full-period frequency modulation new energy generator set, including following steps:
S1: determining whether a grid frequency is within a rated frequency threshold; if the grid frequency is higher than the rated frequency threshold, performing step S2; if the grid frequency is lower than the rated frequency threshold, performing step S3; the rated frequency threshold is generally 50±0.2 Hz.
S2: when the grid frequency is higher than the rated frequency threshold, the hydraulic new energy generator set performs frequency modulation to bring the grid frequency within the rated frequency threshold, specifically including following sub-steps:
S21: performing an initial frequency modulation by reducing a blade rotor kinetic energy and decreasing a valve opening of a proportional throttle valve; during the frequency modulation, determining whether the grid frequency is within the rated frequency threshold in real time; if the grid frequency reaches the rated frequency threshold, the frequency modulation ends; if the blade rotor kinetic energy and the valve opening of the proportional throttle valve both reach minimum thresholds and the grid frequency remains higher than the rated frequency threshold, performing step S22;
S22: performing a secondary frequency modulation by using a second bidirectional variable hydraulic motor and the energy conversion element functioning as a hydraulic pump to store excess energy as hydraulic energy in a bladder accumulator; during the frequency modulation, determining whether the grid frequency is within the rated frequency threshold in real time; if the grid frequency reaches the rated frequency threshold, the frequency modulation ends; if the bladder accumulator is fully charged with the hydraulic energy and the grid frequency remains higher than the rated frequency threshold, performing step S23;
S23: performing a tertiary frequency modulation by using the excess energy generated by blades to drive the second bidirectional variable hydraulic motor, thereby driving a water pump to store seawater as hydraulic energy in a water storage tank; during the frequency modulation, determining whether the grid frequency is within the rated frequency threshold in real time; if the grid frequency reaches the rated frequency threshold, the frequency modulation ends;
S3: when the grid frequency is lower than the rated frequency threshold, the hydraulic new energy generator set performs frequency modulation to bring the grid frequency within the rated frequency threshold, specifically including following sub-steps:
S31: performing the initial frequency modulation by increasing the blade rotor kinetic energy through frequency control and increasing the valve opening of the proportional throttle valve; during the frequency modulation, determining whether the grid frequency is within the rated frequency threshold in real time; if the grid frequency reaches the rated frequency threshold, the frequency modulation ends; if both the blade rotor kinetic energy and the valve opening of the proportional throttle valve reach the maximum thresholds and the grid frequency remains lower than the rated frequency threshold, performing step S32;
S32: performing the secondary frequency modulation by releasing the hydraulic energy stored in the bladder accumulator to drive the energy conversion element functioning as a hydraulic motor, thereby driving the third excitation synchronous generator to generate electricity; during the frequency modulation, determining whether the grid frequency is within the rated frequency threshold in real time; if the grid frequency reaches the rated frequency threshold, the frequency modulation ends; if the hydraulic energy in the bladder accumulator is fully released and the grid frequency remains lower than the rated frequency threshold, performing step S33;
S33: performing the tertiary frequency modulation by allowing the seawater stored in the water storage tank to flow downward, driving a water turbine to rotate and thereby driving a second excitation synchronous generator to generate electricity; during the frequency modulation, determining whether the grid frequency is within the rated frequency threshold in real time; when the grid frequency reaches the rated frequency threshold, the frequency modulation ends.

When the hydraulic new energy generator set performs the initial frequency modulation, the blade rotor kinetic energy is adjusted through an additional frequency control to meet the frequency modulation requirement; the frequency modulation requirement is a rotational inertia of a first excitation synchronous generator, which is:

$${J}_{virl} = \frac{{J}_{w} {ω}_{w 0} {Δω}_{w}}{{ω}_{s} {Δω}_{s}}$$

wherein Jₛ is a total inertia of the blade and a load converted to a blade shaft; ω_{w0} is a rotational speed under maximum power point tracking; and ωₛ is a synchronous speed;

$$Δ {ω}_{w} = {ω}_{w 1} - {ω}_{w 0}$$

wherein ω_{w1} is a minimum operating speed of the blade;

$$Δ {ω}_{s} = {ω}_{s 1} - {ω}_{s 0}$$

wherein ωₛ₁ is the rotational speed of the generator after meeting the frequency modulation requirement;
by adjusting an output active power, a rotational kinetic energy of the blade is used to support a rotor kinetic energy of the generator to compensate for the power; the active power compensated by a virtual inertia control of the blade is:

$$Δ {P}_{1} = - {K}_{df} \frac{d Δ f}{d t}$$

wherein ΔP₁ is the power compensated by the virtual inertia control; Δf is a system frequency deviation; and K_{df} is a virtual inertia coefficient.

When the hydraulic new energy generator set performs the secondary frequency modulation, a frequency variation is introduced to implement additional control on a hydraulic energy storage system; the virtual droop control is used to respond to system frequency changes; the active power compensated by the virtual droop control of the blade is:

$$Δ {P}_{2} = - {K}_{pf} Δ f$$

wherein ΔP₂ is a power compensated by the virtual droop control; K_{pf} is a virtual droop coefficient; and Δf is a system frequency deviation.

On another aspect, as shown in FIG. 1, the hydraulic full-period frequency modulation new energy generator set of the present disclosure includes a blade 1, a unidirectional fixed-displacement hydraulic pump, a first coupler 301, a second coupler 302, a third coupler 303, a fourth coupler 304, a fifth coupler 305, a proportional throttle valve 4, a first bidirectional variable hydraulic motor 501, a second bidirectional variable hydraulic motor 502, a first excitation synchronous generator 601, a second excitation synchronous generator 602, a third excitation synchronous generator 603, a first grid-connected cabinet 701, a second grid-connected cabinet 702, a third grid-connected cabinet 703, a water turbine 8, a water valve 9, a water storage tank 10, a water pump 11, a bladder accumulator 12, an energy conversion element 13, a first hydraulic oil tank 1401, a second hydraulic oil tank 1402, a first overflow valve 1501, a second overflow valve 1502, a generator 16, a make-up pump 17, and a check valve 18.

The blade 1 is connected to the unidirectional fixed-displacement hydraulic pump 2 through the first coupler 301. Under the action of natural wind, ocean currents, or waves near the coast or at sea, the blade 1 drives the unidirectional fixed-displacement hydraulic pump 2 to rotate. High-pressure oil flows out of an outlet of the unidirectional fixed-displacement hydraulic pump 2 and flows into an inlet of the proportional throttle valve 4. The proportional throttle valve 4 may continuously and proportionally control the pressure and flow rate of the hydraulic system, reduce pressure shock and enable control of the actuator, thereby delivering high-pressure oil to the inlets of the first bidirectional variable hydraulic motor 501 and the second bidirectional variable hydraulic motor 502. The above hydraulic components form a closed-loop circuit. In the hydraulic system, to prevent the system pressure from exceeding the rated value, an overflow valve is required to protect the safe operation of the entire system. When the system pressure exceeds the set value of the overflow valve, the overflow valve opens to release excess flow. The inlet of the second overflow valve 1502 is connected to the outlet of the unidirectional fixed-displacement hydraulic pump 2, and the outlet of the second overflow valve 1502 is connected to the inlet of the unidirectional fixed-displacement hydraulic pump 2.

In the closed-loop circuit, internal leakage is inevitable. To ensure stable and normal operation of the closed-loop circuit, a corresponding make-up circuit is required. Here, the make-up circuit is a typical open hydraulic system. The outlet of the unidirectional fixed-displacement hydraulic pump 2 is connected to the inlet of the check valve 18, and an outlet of the check valve 18 is connected to an inlet of the first overflow valve 1501 and an outlet of the make-up pump 17. The check valve 18 prevents backflow when the system pressure is low. The generator 16 drives the make-up pump 17, and an inlet of the make-up pump 17 and an outlet of the first overflow valve 1501 are both connected to the second hydraulic oil tank 1402. The first overflow valve 1501 as a safety valve for the make-up circuit is opened when the make-up circuit pressure exceeds the system pressure. The above hydraulic components form a hydraulic make-up circuit, which replenishes the oil lost due to leakage in the closed-loop circuit.

The first bidirectional variable hydraulic motor 501 is connected to one end of the first excitation synchronous generator 601 through the second coupler 302. The other end of the first excitation synchronous generator 601 is connected to the first grid-connected cabinet 701 and finally integrated into the grid. The second bidirectional variable hydraulic motor 502 is connected to the energy conversion element 13 through the third coupler 303. The energy conversion element 13 is connected to the bladder accumulator 12 and the first hydraulic oil tank 1401 to achieve hydraulic energy conversion. The energy conversion element 13 is connected to the water pump 11 through the fourth coupler 304. The water pump 11 is connected to one end of the third excitation synchronous generator 603 through the fifth coupler 305, and the other end of the third excitation synchronous generator 603 is connected to the third grid-connected cabinet 703 and finally integrated into the grid. The water pump 11 is connected to the water storage tank 10. An inlet of the water valve 9 is connected to the water storage tank 10, and an outlet of the water valve 9 is connected to the water turbine 8. The water turbine 8 is connected to one end of the second excitation synchronous generator 602, and the other end of the second excitation synchronous generator 602 is connected to the second grid-connected cabinet 702 and finally integrated into the grid.

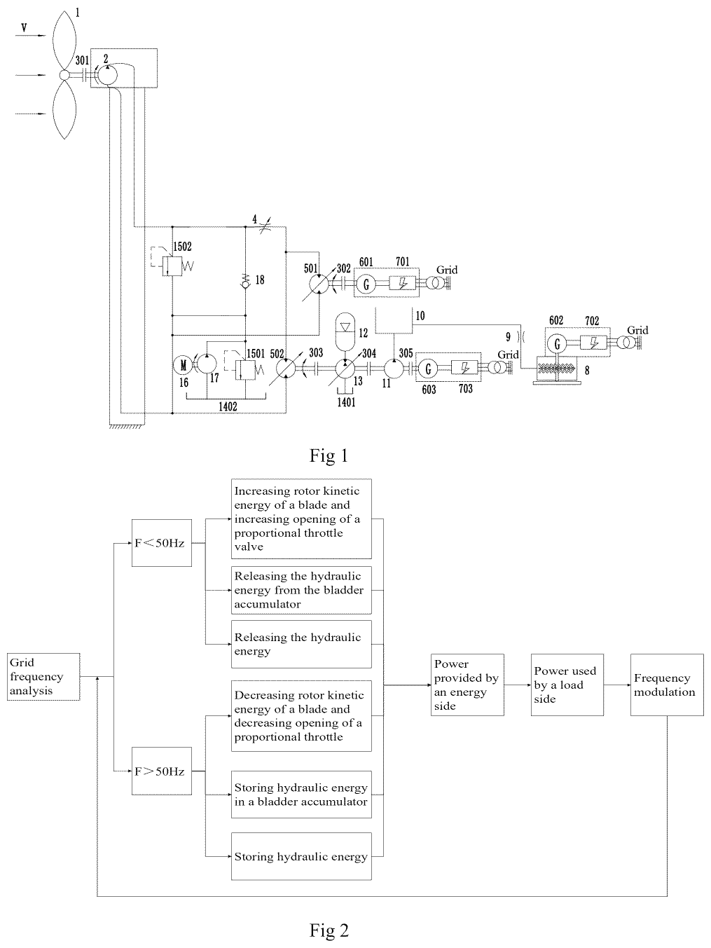

The entire hydraulic new energy generator set may generate electricity and perform frequency modulation. The first bidirectional variable hydraulic motor 501 drives the first excitation synchronous generator 601 through the second coupler 302, and the generator is integrated into the grid through the first grid-connected cabinet 701, achieving the power generation process of the hydraulic new energy generator. The full frequency range frequency modulation strategy view of the hydraulic full-period frequency modulation new energy generator set is shown in FIG. 2. First, the grid frequency is analyzed. When the hydraulic new energy generator set is in the initial frequency modulation stage and the frequency is f>50 Hz, the frequency modulation is performed by reducing the rotor kinetic energy of the blade 1 and increasing the opening of the proportional throttle valve 4. When the frequency is f<50 Hz, the frequency modulation is performed by increasing the rotor kinetic energy of the blade 1 and decreasing the opening of the proportional throttle valve 4. When the hydraulic new energy generator set is in the secondary frequency modulation stage and the frequency is f>50 Hz, frequency modulation is performed by storing excess energy as hydraulic energy in the bladder accumulator 12. When the frequency is f<50 Hz, the frequency modulation is performed by releasing the hydraulic energy stored in the bladder accumulator 12. When the hydraulic new energy generator set is in the tertiary frequency modulation stage and the frequency is f>50 Hz, the frequency modulation is performed by using the water pump 11 to transport seawater from the coast or around the island to the water storage tank 10 on offshore highlands or islands, storing it as hydraulic energy. When the frequency is f<50 Hz, frequency modulation is performed by releasing the water stored in the water storage tank 10 on offshore highlands or islands to drive the water turbine 8. The power provided by the energy side and the power used by the load side are then compared until a balance can be achieved. Otherwise, the frequency modulation rate is fed back to the hydraulic new energy generator set for further frequency modulation.

For load disturbances, the hydraulic full-period frequency modulation generator set performs the frequency modulation control based on the aforementioned wind-storage combined control strategy. Experimental results show that both fixed-parameter and variable-parameter controls significantly change the system frequency response, with variable-parameter control outperforming fixed-parameter control. When the hydraulic new energy generator set performs fixed-parameter frequency modulation control, its control parameters are fixed at K_{pf}=15 [symbol] K_{df}=5.

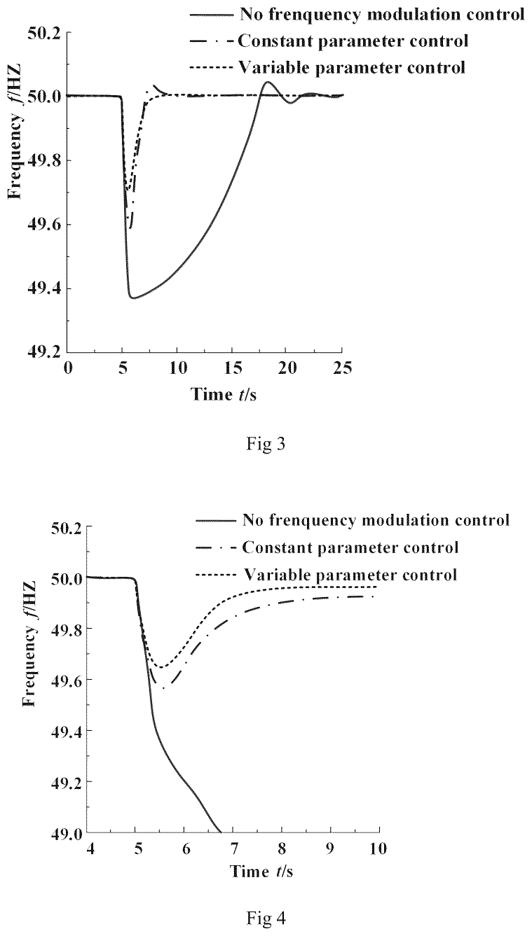

FIG. 3 is a simulation view of a system response when a load of the hydraulic full-period frequency modulation new energy generator set suddenly increases by 10.5 kW. After introducing the wind-storage combined frequency modulation control strategy to the wind turbine, the system frequency response characteristics change significantly. The maximum frequency deviation decreases noticeably, and the frequency regulation time shortens significantly. The lowest frequency drop increases from 49.37 Hz to 49.58 Hz, and the maximum frequency deviation decreases from 0.63 Hz to 0.42 Hz. The frequency regulation time decreases from 12 s without frequency modulation control to 3 s.

FIG. 4 is a simulation view of the system response when the load of the hydraulic full-period frequency modulation new energy generator set suddenly increases by 12 kW. After introducing the wind-storage combined frequency modulation control strategy to the wind turbine, the system frequency changes from a continuous drop state to a recoverable state. Under fixed-parameter control, the frequency reaches its lowest point of 49.52 Hz at 5.7 s after the frequency modulation control by the wind turbine, with a maximum frequency deviation of 0.48 Hz. The system stabilizes at 49.92 Hz at 9.6 s, with a steady-state frequency deviation of 0.08 Hz.

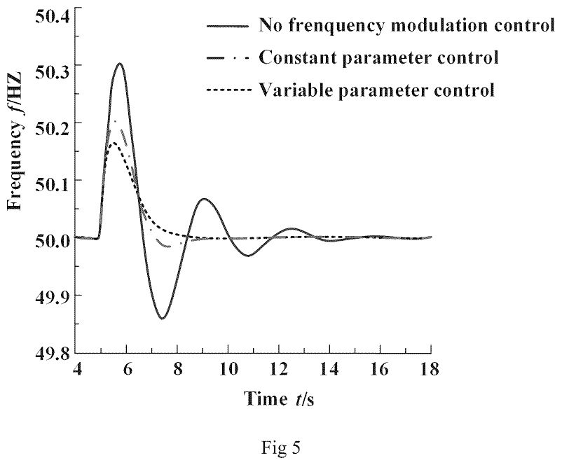

FIG. 5 is a simulation view of the system response when the load of the hydraulic full-period frequency modulation new energy generator set suddenly decreases by 6 kW. When fixed-parameter frequency modulation control is applied, the frequency rises to its highest point of 50.23 Hz at 5.5 s, and the frequency stabilizes approximately 3 s after the load disturbance. Compared to no frequency modulation control, introducing frequency modulation control significantly reduces the maximum frequency deviation and frequency regulation time. The maximum frequency deviation decreases from 50.35 Hz to 50.23 Hz, and the frequency regulation time decreases from 8 s to 3 s. Additionally, the frequency rise time shortens from 5.7 s to 5.5 s. The frequency modulation control strategy significantly can improve frequency stability, greatly reduce load fluctuations and enhance the frequency stability of the hydraulic new energy generator set.

Specifically, in a specific embodiment, an optimal speed corresponding to the wind speed is between a start-up speed and a rated speed. The first excitation synchronous generator 601 is directly connected to the grid, and its rotor speed n is coupled to the system frequency f.

$$n = 60 f / p$$

wherein p is the number of pole pairs of the motor.

In high wind speed conditions, when the grid frequency exceeds 50 Hz, the rotor speed n increases as the frequency f increases. Therefore, the entire hydraulic new energy generator set needs to reduce the speed for frequency modulation control. Thus, the blade 1 is feathered to make it perpendicular to the wind direction, thereby increasing its resistance and reducing its rotor kinetic energy. Simultaneously, the opening of the proportional throttle valve 4 is reduced to dissipate the excess energy transmitted by the blade 1 through the unidirectional fixed-displacement hydraulic pump 2 as heat. The high-pressure oil reaching the inlet of the first bidirectional variable hydraulic motor 501 decreases, thereby reducing its speed. The speed transmitted to the first excitation synchronous generator 601 through the second coupler 302 also decreases, thereby reducing the power output from the energy side to achieve the initial frequency modulation.

If the grid frequency still exceeds the frequency threshold range, the second bidirectional variable hydraulic motor and the energy conversion element functioning as a hydraulic pump store the excess energy as hydraulic energy in the bladder accumulator for secondary frequency modulation. During the frequency modulation, the grid frequency is monitored in real time to determine if it is within the rated frequency threshold. If the grid frequency reaches the rated frequency threshold, the frequency modulation ends. If the bladder accumulator is fully charged and the grid frequency still exceeds the rated frequency threshold, the excess energy generated by the blade drives the second bidirectional variable hydraulic motor, which in turn drives the water pump to transport seawater to the water storage tank, storing it as hydraulic energy for tertiary frequency modulation. During the frequency modulation, the grid frequency is monitored in real time to determine if it is within the rated frequency threshold. When the grid frequency reaches the rated frequency threshold, the frequency modulation ends.

In low wind speed conditions, when the grid frequency is below 50 Hz, the rotor speed n decreases as the frequency f decreases. Therefore, the entire hydraulic new energy generator set needs to increase the speed for frequency modulation control. Thus, the blade 1 is pitched to make it parallel to the wind direction, thereby reducing its resistance and increasing its rotor kinetic energy. Simultaneously, the opening of the proportional throttle valve 4 is increased. The high-pressure oil transmitted from the unidirectional fixed-displacement hydraulic pump 2 to the inlet of the first bidirectional variable hydraulic motor 501 increases, thereby raising its speed. The speed transmitted to the first excitation synchronous generator 601 through the second coupler 302 also increases, thereby increasing the power output from the energy side to achieve the initial frequency modulation.

During frequency fluctuations, both the blade 1 and the first excitation synchronous generator 601 contain rotor kinetic energy. However, since the blade 1 is not directly connected to the first excitation synchronous generator 601 on the same shaft, it cannot directly provide inertial support. By introducing an additional frequency control loop, the rotor kinetic energy of the blade 1 is released to meet the frequency modulation requirements. Thus, the blade 1 is considered to provide inertial support to the frequency similar to the first excitation synchronous generator 601. The energy provided by the blade 1 for system inertial response is defined as a virtual inertia of the blade 1. The kinetic energy provided by the blade 1 during the frequency modulation is:

$$Δ E = \frac{1}{2} {J}_{w} ( {ω}_{w 1}^{2} - {ω}_{w 0}^{2} )$$

Wherein K is a total inertia of the blade 1 and a load converted to the blade shaft; ωᵥ₀ is a rotational speed under maximum power point tracking; and ω_{w1} is a minimum operating speed of the blade.

Compared to the traditional synchronous generators, the hydraulic wind turbine set satisfies:

$$Δ E = \frac{1}{2} {J}_{vir 1} ( {ω}_{s 1}^{2} - {ω}_{s}^{2} )$$

wherein Jᵥᵢᵣ₁ is an inertia of the blade 1 and a load converted to the blade shaft; ωₛ is a synchronous speed; and ωₛ₁ is a rotational speed of the synchronous generator after meeting the frequency modulation requirements.

Compared to the blade 1, the rotational inertia of the first excitation synchronous generator 601 satisfies:

$${J}_{vir 1} = \frac{{J}_{w} {ω}_{w 0} Δ {ω}_{w}}{{ω}_{s} Δ {ω}_{s}}$$

wherein Δωₛ=ω_{w1}−ω_{w0} and Δωₛ=ωₛ₁−ωₛ.

In addition to the generator releasing its own rotational kinetic energy to respond to frequency fluctuations, the rotor kinetic energy of the blade 1 can further support the generator's rotor kinetic energy to compensate for power, providing inertial support from the blade 1 during the frequency fluctuations. This allows the driving power on the generator shaft to change, balancing the active power on the grid side and maintaining frequency stability. The active power compensated by the virtual inertia control loop of the blade 1 during frequency fluctuations is:

$$Δ {P}_{1} = - {K}_{df} \frac{d Δ f}{d t}$$

wherein ΔP₁ is a power compensated by the virtual inertia control; Δf is a system frequency deviation; and K_{df} is a virtual inertia coefficient.

After the initial frequency modulation, if the grid frequency still falls below the frequency threshold range, the hydraulic energy stored in the bladder accumulator is released to drive the energy conversion element functioning as a hydraulic motor, which in turn drives the third excitation synchronous generator to generate electricity for secondary frequency modulation. During the frequency modulation, the grid frequency is monitored in real time to determine if it is within the rated frequency threshold. If the grid frequency reaches the rated frequency threshold, the frequency modulation ends. If the hydraulic energy in the bladder accumulator is fully released and the grid frequency still falls below the rated frequency threshold, the seawater stored in the water storage tank flows downward to drive the water turbine, which in turn drives the second excitation synchronous generator to generate electricity for tertiary frequency modulation. During the frequency modulation, the grid frequency is monitored in real time to determine if it is within the rated frequency threshold. When the grid frequency reaches the rated frequency threshold, the frequency modulation ends.

During the secondary frequency modulation, by comparing with the droop characteristics of generators, the frequency variation may be introduced to implement additional control on the hydraulic energy storage system. The virtual droop control loop is used to respond to system frequency changes. The active power compensated by the virtual droop control loop of the blade 1 is:

$$Δ {P}_{2} = - {K}_{pf} Δ f$$

wherein ΔP₂ is a power compensated by the virtual droop control; K_{pf} is a virtual droop coefficient; and Δf is a system frequency deviation. The larger the frequency deviation, the more power the virtual droop loop compensates, thereby reducing the deviation.

The above-described embodiments are only preferred implementations of the present disclosure and do not limit the scope of the present disclosure. Without departing from the design spirit of the present disclosure, various modifications and improvements made by those skilled in the art to the technical solutions of the present disclosure shall fall within the protection scope defined by the claims of the present disclosure.

What is claimed is:

1. A primary frequency modulation method for a hydraulic full-period frequency modulation new energy generator set, comprising following steps:
S1: determining whether a grid frequency is within a rated frequency threshold; if the grid frequency is higher than the rated frequency threshold, performing step S2; if the grid frequency is lower than the rated frequency threshold, performing step S3;
S2: when the grid frequency is higher than the rated frequency threshold, the hydraulic new energy generator set performs frequency modulation to bring the grid frequency within the rated frequency threshold, specifically comprising following sub-steps:
S21: performing an initial frequency modulation by reducing a blade rotor kinetic energy and decreasing a valve opening of a proportional throttle valve; during the frequency modulation, determining whether the grid frequency is within the rated frequency threshold in real time; if the grid frequency reaches the rated frequency threshold, the frequency modulation ends; if the blade rotor kinetic energy and the valve opening of the proportional throttle valve both reach minimum thresholds and the grid frequency remains higher than the rated frequency threshold, performing step S22;
S22: performing a secondary frequency modulation by using a second bidirectional variable hydraulic motor and the energy conversion element functioning as a hydraulic pump to store excess energy as hydraulic energy in a bladder accumulator; during the frequency modulation, determining whether the grid frequency is within the rated frequency threshold in real time; if the grid frequency reaches the rated frequency threshold, the frequency modulation ends; if the bladder accumulator is fully charged with the hydraulic energy and the grid frequency remains higher than the rated frequency threshold, performing step S23;
S23: performing a tertiary frequency modulation by using the excess energy generated by blades to drive the second bidirectional variable hydraulic motor, thereby driving a water pump to store seawater as hydraulic energy in a water storage tank; during the frequency modulation, determining whether the grid frequency is within the rated frequency threshold in real time; if the grid frequency reaches the rated frequency threshold, the frequency modulation ends;
S3: when the grid frequency is lower than the rated frequency threshold, the hydraulic new energy generator set performs frequency modulation to bring the grid frequency within the rated frequency threshold, specifically comprising following sub-steps:
S31: performing the initial frequency modulation by increasing the blade rotor kinetic energy through frequency control and increasing the valve opening of the proportional throttle valve; during the frequency modulation, determining whether the grid frequency is within the rated frequency threshold in real time; if the grid frequency reaches the rated frequency threshold, the frequency modulation ends; if both the blade rotor kinetic energy and the valve opening of the proportional throttle valve reach the maximum thresholds and the grid frequency remains lower than the rated frequency threshold, performing step S32;
S32: performing the secondary frequency modulation by releasing the hydraulic energy stored in the bladder accumulator to drive the energy conversion element functioning as a hydraulic motor, thereby driving the third excitation synchronous generator to generate electricity; during the frequency modulation, determining whether the grid frequency is within the rated frequency threshold in real time; if the grid frequency reaches the rated frequency threshold, the frequency modulation ends; if the hydraulic energy in the bladder accumulator is fully released and the grid frequency remains lower than the rated frequency threshold, performing step S33;
S33: performing the tertiary frequency modulation by allowing the seawater stored in the water storage tank to flow downward, driving a water turbine to rotate and thereby driving a second excitation synchronous generator to generate electricity; during the frequency modulation, determining whether the grid frequency is within the rated frequency threshold in real time; when the grid frequency reaches the rated frequency threshold, the frequency modulation ends.

2. The primary frequency modulation method for the hydraulic full-period frequency modulation new energy generator set according to claim 1, wherein in step S31, when the hydraulic new energy generator set performs the initial frequency modulation, the blade rotor kinetic energy is adjusted through frequency control to meet the frequency modulation requirement; the frequency modulation requirement is a rotational inertia of a first excitation synchronous generator, which is:
$${J}_{vir 1} = \frac{{J}_{w} {ω}_{w 0} Δ {ω}_{w}}{{ω}_{s} Δ {ω}_{s}}$$
wherein Jₛ is a total inertia of the blade and a load converted to a blade shaft; ω_{w0} is a rotational speed under maximum power point tracking; and ωₛ is a synchronous speed;
$$Δ {ω}_{w} = {ω}_{w 1} - {ω}_{w 0}$$
wherein ω_{w1} is a minimum operating speed of the blade;
$$Δ {ω}_{s} = {ω}_{s 1} - {ω}_{s}$$
wherein ωₛ₁ is the rotational speed of the generator after meeting the frequency modulation requirement;
by adjusting an output active power, a rotational kinetic energy of the blade is used to support a rotor kinetic energy of the generator to compensate for the power; the active power compensated by a virtual inertia control of the blade is:
$$Δ {P}_{1} = - {K}_{df} \frac{d Δ f}{d t}$$
wherein ΔP₁ is the power compensated by the virtual inertia control; Δf is a system frequency deviation; and K_{df} is a virtual inertia coefficient.

3. The primary frequency modulation method for the hydraulic full-period frequency modulation new energy generator set according to claim 1, wherein when the hydraulic new energy generator set performs the secondary frequency modulation, a frequency variation is introduced to implement additional control on a hydraulic energy storage system; the virtual droop control is used to respond to system frequency changes; the active power compensated by the virtual droop control of the blade is:
$$Δ {P}_{2} = - {K}_{pf} Δ f$$
wherein ΔP₂ is a power compensated by the virtual droop control; K_{pf} is a virtual droop coefficient; and Δf is a system frequency deviation.

4. The primary frequency modulation method for the hydraulic full-period frequency modulation new energy generator set according to claim 1, wherein the rated frequency threshold is 50±0.2 Hz.

5. A hydraulic full-period frequency modulation new energy generator set for implementing the primary frequency modulation method according to claim 1, comprising: a blade, an unidirectional fixed-displacement hydraulic pump, a proportional throttle valve, a first bidirectional variable hydraulic motor, a second bidirectional variable hydraulic motor, a first excitation synchronous generator, a second excitation synchronous generator, a third excitation synchronous generator, a water turbine, a water valve, a water storage tank, a water pump, a bladder accumulator, an energy conversion element, a first hydraulic oil tank, a second hydraulic oil tank, a first overflow valve, a second overflow valve, a generator, a make-up pump, and a check valve; and the first excitation synchronous generator, the second excitation synchronous generator, and the third excitation synchronous generator being all connected to the grid;
wherein the blade is connected to the unidirectional fixed-displacement hydraulic pump; an inlet of the second overflow valve is connected to an outlet of the unidirectional fixed-displacement hydraulic pump, and an outlet of the second overflow valve is connected to an inlet of the unidirectional fixed-displacement hydraulic pump; an inlet of the proportional throttle valve is connected to an outlet of the unidirectional fixed-displacement hydraulic pump; an inlet of the first bidirectional variable hydraulic motor is connected to an outlet of the proportional throttle valve, and an outlet of the first bidirectional variable hydraulic motor is connected to an inlet of the unidirectional fixed-displacement hydraulic pump; the first excitation synchronous generator is connected to the first bidirectional variable hydraulic motor;
wherein an inlet of the second bidirectional variable hydraulic motor is connected to the outlet of the proportional throttle valve; the second bidirectional variable hydraulic motor is connected to the energy conversion element; the energy conversion element is connected to the bladder accumulator and the first hydraulic oil tank; the energy conversion element is also connected to the water pump; the water pump is connected to the third excitation synchronous generator; the water pump is connected to an inlet of the water storage tank; the inlet of the water valve is connected to an outlet of the water storage tank; and the outlet of the water valve is connected to the water turbine; and the water turbine is connected to the second excitation synchronous generator;
wherein an inlet of the check valve is connected to an outlet of the unidirectional fixed-displacement hydraulic pump, and an outlet of the check valve is connected to an outlet of the make-up pump and the inlet of the first overflow valve; the generator drives the make-up pump, and the inlet of the make-up pump and the outlet of the first overflow valve are both connected to the second hydraulic oil tank.

6. The hydraulic full-period frequency modulation new energy generator set according to claim 5, wherein the unidirectional fixed-displacement hydraulic pump, the proportional throttle valve, the first bidirectional variable hydraulic motor, and the second bidirectional variable hydraulic motor form a hydraulic closed-loop circuit.

7. The hydraulic full-period frequency modulation new energy generator set according to claim 5, wherein the check valve, the first overflow valve, the make-up pump, and the generator form a hydraulic make-up circuit.

8. The hydraulic full-period frequency modulation new energy generator set according to claim 5, wherein the blade is connected to the unidirectional fixed-displacement hydraulic pump through a first coupler; the first excitation synchronous generator is connected to the first bidirectional variable hydraulic motor through a second coupler; the second bidirectional variable hydraulic motor is connected to the energy conversion element through a third coupler; the energy conversion element is connected to the water pump through a fourth coupler; and the water pump is connected to the third excitation synchronous generator through a fifth coupler.

9. The hydraulic full-period frequency modulation new energy generator set according to claim 5, wherein the first excitation synchronous generator is connected to a first grid-connected cabinet and then connected to the grid; the second excitation synchronous generator is connected to a second grid-connected cabinet and then connected to the grid; the third excitation synchronous generator is connected to a third grid-connected cabinet and then connected to the grid.
